(19) United States
(12) Patent Application Publication
(10) Pub. No.: US 2023/0256575 A1
(43) Pub. Date: Aug. 17, 2023

(54) FOLDABLE TOOL FOR RELEASING A SEMI-TRAILER FROM A TRUCK TRACTOR

(71) Applicant: Rodney Polensky, Meridian, ID (US)

(72) Inventor: Rodney Polensky, Meridian, ID (US)

(21) Appl. No.: 18/168,543

(22) Filed: Feb. 13, 2023

Related U.S. Application Data
(60) Provisional application No. 63/309,398, filed on Feb. 11, 2022.

(51) Int. Cl. B25B 27/00; B25B 27/14

(52) U.S. Cl. CPC B25B 27/0035; B25B 27/14

(57) ABSTRACT

The present invention is a system and method for providing a release tool comprised of a metal reinforced webbing that when unrolled is sufficiently strong enough to form a rigid length having one end with a hook that can be extended between the semi-trailer and the truck tractor frame and be attached to the latch mechanism, and having another end with a handle that the user may pull on to disengage the latch mechanism and release the semi-trailer from the fifth wheel, and wherein the release tool may then be rolled up or folded into a compact shape and stored for later use.

### BACKGROUND

### Field of the Invention

This invention relates generally to a release tool that is used to pull on a latch mechanism that secures a semi-trailer to a truck tractor, wherein the release tool is able to extend underneath the semi-trailer, grab onto the latch mechanism and provide a sufficiently strong handle that enables the user to release the latch mechanism, wherein the release tool is rolled up or folded when not in use, and is unrolled to a rigid length when it is ready to be used.

### Description of Related Art

Semi-trailer trucks are well known throughout the world in which an independent truck trailer can interchangeably be connected to practically any desired truck tractor cab for transporting the trailer and its contents to any desired location. While the truck tractor and semi-trailer can take any one of a large variety of different forms and sizes, depending on the intended use and intended load to be transported, the interconnection between the truck tractor and the semi-trailer has developed into a uniform standard design so that the truck tractors and the semi-trailers can readily be interchanged according to need.

As shown in FIG. 1, the truck tractor is normally provided with a chassis structure such that a portion of the truck tractor frame 10 extends rearwardly of the cab 12 with one or more drive axles 14, upon which the wheels and tires 16 are mounted, supporting the truck tractor on the road surface under the rearwardly extending portion of truck tractor frame 10.

A tiltable, steel disk, commonly referred to as the “fifth wheel” 18, is horizontally disposed on the upper side of the rearwardly extending truck tractor frame 10 of the truck tractor, with the fifth wheel 18 having a diverging “V” slot 20 extending rearwardly from the truck tractor.

The latch mechanism 22 that secures a semi-trailer to the truck tractor at the fifth wheel 18 is inconveniently located close to a center line of the truck tractor frame 10, and also underneath the overhanging semi-trailer (not shown).

As shown in FIG. 1, the fifth wheel 18 guides a post or kingpin (not shown) on the semi-trailer to the latch mechanism 22 that secures the semi-trailer to the truck tractor frame 10.

FIG. 2 is a profile view of a truck tractor 24 with the cab 12, the wheels and tires 16, the fifth wheel 18, and a partial outline of a semi-trailer 26.

When the semi-trailer 26 needs to be removed from the truck tractor 24, the latch mechanism 22 must be pulled in order to disengage the kingpin. Unfortunately, the latch mechanism 22 is so far under the semi-trailer 26 that to reach it by hand, a person is going to get dirty from contact with tires 16, the semi-trailer, or both. Accordingly, it is desirable to avoid the mess and use a tool to reach under the semi-trailer 26 and above the truck tractor frame 10 and grab the latch mechanism 22 and then pull on it to disengage the kingpin and release the semi-trailer. The truck tractor 24 will then typically pull away from the semi-trailer 26, leaving it supported on its own tires and landings or landing gear.

There are various release tools that have been developed to reach under the semi-trailer 26, grab the latch mechanism 22, and then allow the user to pull on and then disengage the latch mechanism. However, these prior art release tools have various difficulties with both their use and storage.

In FIG. 3, the prior art references show a release tool 30 that is comprised of a long metal rod 32 with a hook 34 on the end for catching the release mechanism which is used to pull and disengage the release mechanism. Unfortunately, this leaves the truck tractor operator with a long metal rod to store and keep track of.

There are variations of the release tool 30 in the prior art that all include a rod of some length with a hook on the end that is used to reach the latch mechanism.

In another prior art reference, a long metal rod is pivotally coupled to the truck tractor frame for disengaging the latch mechanism from near the truck tractor cab. However, these designs require additions to the truck tractor frame and are not easily removable once attached.

Accordingly, it would be an advantage over the prior art to have a portable release tool that can be used on any latch mechanism and carried from truck to truck. It would also be an advantage to not have a permanently rigid release tool that would occupy a significantly smaller amount of space when stored. It would be a further advantage to provide a release tool that could be easily rolled up or folded so that it is easily storable inside a truck tractor or in a convenient location on a semi-trailer.

### BRIEF SUMMARY

The present invention is a system and method for providing a release tool comprised of a metal reinforced fabric webbing that when unrolled is sufficiently strong enough to form a rigid length having one end with a hook that can be extended between the semi-trailer and the truck tractor frame and be attached to the latch mechanism, and having another end with a handle that the user may pull on to disengage the latch mechanism and release the semi-trailer from the fifth wheel, and wherein the release tool may then be rolled or folded into a compact shape and stored for later use.

In a first aspect of the invention, a metal blade is disposed within the fabric webbing, wherein the metal blade may be rolled up without damaging its ability to be repeatedly unrolled to form a straight and rigid shape.

In a second aspect of the invention, one or more layers of the metal blade may be disposed within the fabric webbing to provide the desired stiffness of the release tool when it is unrolled.

In a third aspect of the invention, the release tool may use a hook that is attached to the working end of the release tool, wherein the hook is a lightweight but sturdy structure that does not cause the release tool to bend the metal blade in the fabric webbing when held at an opposite pulling end of the release tool.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a perspective diagram of a truck tractor showing a truck tractor frame and a fifth wheel disposed on the frame, and an aperture for the kingpin of a semi-trailer.

FIG. 2 is a profile view of a truck tractor, the wheels and tires, the fifth wheel, and a partial outline of a semi-trailer.

FIG. 3 is a release tool shown in the prior art having a rigid rod, a handle on a pulling end and a hook on a working end.

FIG. 4 is a first embodiment of the present invention showing the elements of the first embodiment of the invention including at least one metal blade, a fabric webbing shaft, a hook, and a handle.

FIG. 5 is a profile cross-section view of the metal blade.

FIG. 6 is a profile cross-section view of the metal blade disposed inside the fabric webbing shaft.

FIG. 7 a view of the hook that may be attached to the pulling end of the release tool.

FIG. 8 is a view of the handle made from the fabric webbing shaft on the working end of the release tool.

FIG. 9 is a profile view of the release tool that has been folded in a serpentine shape for storage.

FIG. 10 is a profile view of the release tool that has been coiled or storage.

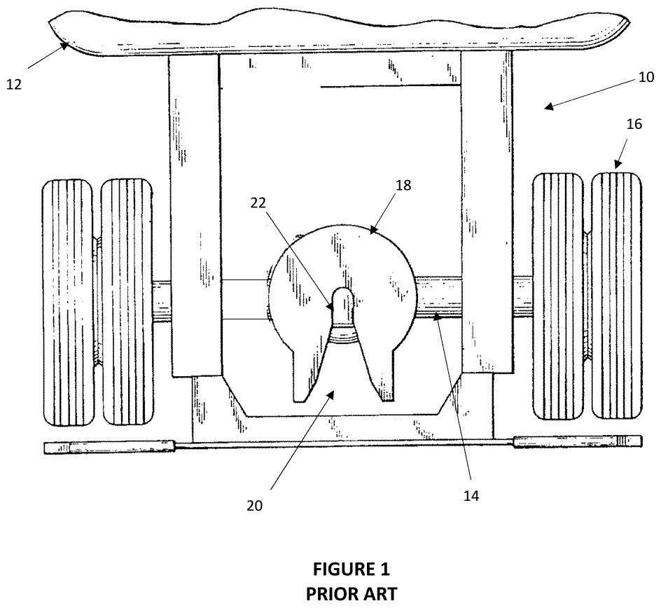

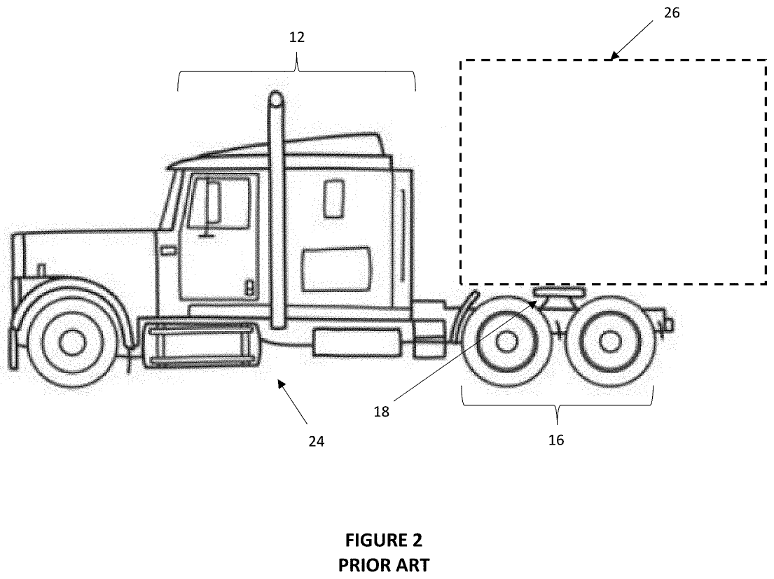

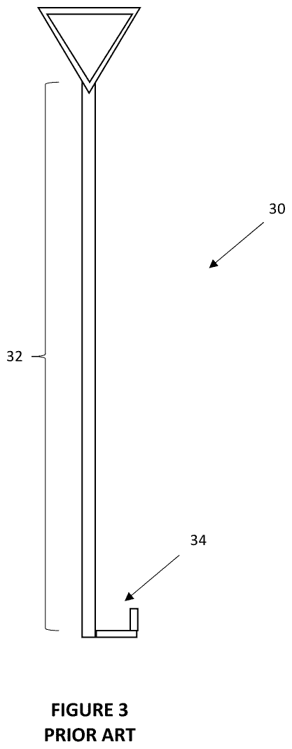

### DETAILED DESCRIPTION

Reference will now be made to the drawings in which the various embodiments of the present invention will be discussed so as to enable one skilled in the art to make and use the invention. It is to be understood that the following description illustrates embodiments of the present invention and should not be viewed as narrowing the claims which follow.

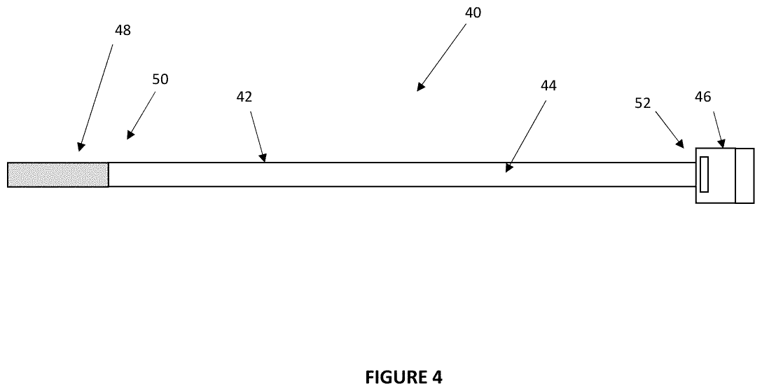

FIG. 4 is a top view of a first embodiment of the present invention showing the present invention which is an expandable release tool 40. The expandable release tool 40 may be comprised of a fabric webbing shaft 42, a metal blade 44 disposed inside the fabric webbing shaft (not shown), a hook 46, and a handle 48.

The length of the at least one metal blade 44 is sufficiently long enough for a user to hold a pulling end 50 of the release tool 40 and for a working end 52 to reach the latch mechanism.

The metal blade 44 may be comprised of any metal that is easily foldable or rollable without damaging the ability of the metal blade to expand (meaning to unroll or unfold) and be rigid. For example, the metal blade 44 may be comprised of a thin aluminum. It should be understood that the metal blade 44 is not meant to be permanently crimped or deformed by rolling or folding. The metal blade 44 of the first embodiment is a relatively thin metal that includes a concave indentation across its width.

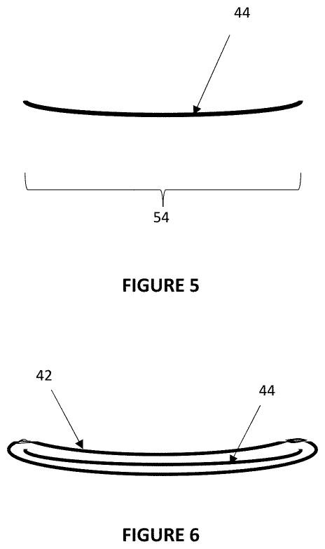

For example, FIG. 5 is an end view of the metal blade 44 showing a width 54. The metal blade 44 is shown having a cross-section that is concave relative to a top view. The concave cross-section of the metal blade 44 gives the thin metal blade its ability to stay rigid when it is unfolded or unrolled, in the same manner as a metal tape measurer.

The metal blade 44 may become rigid when extended by having the concave deformation in the metal in much the same manner as a metal tape measure. In other words, one side of the metal blade is a concave surface while the opposite side is a corresponding convex surface.

The opposite concave and convex surfaces extend along the length of the metal blade 44. Thus, when the metal blade 44 is extended, the metal blade is made rigid by the deformation causing the concave and convex surfaces. These surfaces also allow the metal blade 44 to be rolled up along its length just as a metal tape measurer is also able to be rolled or folded back and forth. As long as the metal blade 44 is not bent so as to permanently mechanically deform the surface of the metal blade, the metal blade can be rolled and unrolled or folded and unfolded as many times as desired.

However, it is the use of the fabric webbing shaft 42 around the metal blade 44 that gives the expandable release tool 40 the ability to be more resilient than a metal tape measurer and resist permanent mechanical crimping. The fabric webbing shaft 42 reinforces the rigidity of the metal blade 44 that is inside it when it is unfolded. In addition, the fabric webbing shaft 42 also assists the metal blade 44 from being accidentally crimped and permanently deformed by resisting harsh bending.

Resisting harsh bending is possible because of the nature of the fabric webbing shaft 42. The fabric webbing shaft 42 may be formed as a tube that takes the shape of the metal blade 44 that is disposed inside of it. The fabric webbing shaft 42 is also durable, resistant to tearing, and has a thickness that is conducive to keeping the metal blade 44 in its proper shape inside the material.

FIG. 6 is a cross-section view of the fabric webbing shaft 42 formed as a tube and wrapped around the metal blade 44. While showing a gap between the fabric webbing shaft 42 and the metal blade 44, they are actually in close contact with each other.

The material used for fabric webbing shaft 42 may be a nylon webbing material which is stronger than polypropylene webbing. However, any appropriate webbing material may be used. The advantage of the nylon webbing is a high tensile strength of anywhere from 2000 to over 5000 pounds per inch, durability, and abrasion resistance. The nylon webbing may be Denier Nylon, where Denier is the name given to the width and thickness of the fibers that make up fabric like nylon. Denier Nylon is a very durable, heavy, and finely woven fabric suitable for a range of purposes.

The length of the metal blade 44 used in the first embodiment of the invention is approximately 30 inches, and the width is approximately 0.75 inches. However, it should be understood that this length and the width of the metal blade may be increased or decreased as desired, and the claims should not be considered as limited by these given dimensions. However, these are convenient dimensions for the metal blade 44 because this product is easily obtainable as the metal blade of this width and desired thickness is often used for metal tape measurers.

An important aspect of the first embodiment is that the strength of the metal blade may need to be reinforced by using more than one layer of the metal blade 44 or a thicker metal blade. It has been determined that a metal blade of the above dimensions is able to support its own weight, the weight of the fabric webbing 42 while the user is holding the pulling end of the release tool 40, and the weight of the hook 46. However, longer lengths of a release tool 40 may be desired and this is possible using the principles of the first embodiment of the invention.

The one of more layers of the metal blade 44 may be inserted into a tube or sleeve made for the fabric webbing shaft 42. Such fabric webbing shaft 42 is available in large quantities and may be cut to the desired length. Thus, when the one or more layers of the metal blade 44 are cut to the desired length, the metal blade or blades are inserted into the fabric webbing shaft 44 and then sewn shut so that the metal blades or blades 44 are sealed inside.

As explained above, the specific fabric webbing chosen should be sufficiently durable to protect the metal blade 44 within and support the hook 46 and the handle 48 on the ends thereof. Such a fabric webbing shaft 42 may be known in the industry as tubular webbing. The tubular webbing is approximately 1 inch wide when flattened and may be comprised of sublimated polyester or nylon. Such webbing commonly has a thickness of 0.045 to 0.055 inches, a tensile breaking strength of 2200 pounds, and a melting point of 500 degrees Fahrenheit. Thus, the fabric webbing shaft 44 is a tough and durable material that may function as desired.

While the specific characteristics are given above for the fabric webbing shaft 42 used in the first embodiment of the invention, it should be understood that the characteristics may be altered without materially changing the nature of the invention or extending beyond the scope of the claims.

The fabric webbing shaft 42 may initially be open at both ends and may then be sealed at each end by sewing or stapling the ends of the fabric webbing shaft.

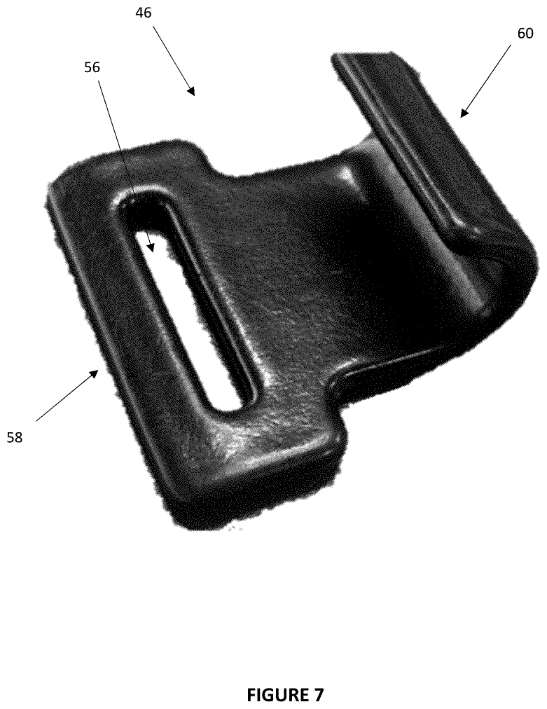

As shown in FIG. 7, the hook 46 may include a slit or gap 56 at a working end 58 of the hook for insertion of the fabric webbing shaft 42. The fabric webbing shaft 42 may be folded over at the working end 58 of the hook after passing through the slit 56 and then sewed or stapled to itself. The hook 46 also includes a hooking end 60. The hook 46 may be made of a lightweight material that does not cause the fabric webbing shaft 42 to bend when it is extended to disengage the latch mechanism 22. Thus, the hook 46 may be nylon, plastic, rigid rubber, lightweight metal such as aluminum, a composite, steel, or any other material that is lightweight and yet strong enough not to deform when releasing the latch mechanism 22.

In the first embodiment, at the end of the fabric webbing shaft 42 opposite the hook 46, the shaft may be sealed, or it may be sewn or stapled into a loop to form the handle 48. If sewn or stapled to form the handle 48, the user may pull on the handle to release the latch mechanism 22 on the fifth wheel 18.

If the fabric webbing shaft 42 is sealed by sewing shut or stapling, a handle 48 may then be attached to this pulling end of the release tool 40. The handle 48 may be attached by any convenient means to the fabric webbing shaft 42 including sewing or stapling.

The fabric webbing shaft 42 may reinforce the metal blade 44 when it is extended to its full length and is being used as the release tool 40. The fabric webbing shaft 42 may also provide a convenient means for attaching the hook 46 and the handle 48 at opposite ends of the release tool 40.

The fabric webbing shaft 42 may be sewn using conventional techniques to finish the ends. For example, the ends of the fabric webbing shaft 42 may be finished using a Box-X stitch. What is important is that the hook 46 be securely fastened to the fabric webbing shaft 42.

In the first embodiment of the invention, a composite hook material is being used. However, it should be understood that that the weight of the hook may be increased and decreased by using different materials and thicknesses of materials. All that is important is that the hook have sufficient strength to not bend when the user is pulling on the release tool.

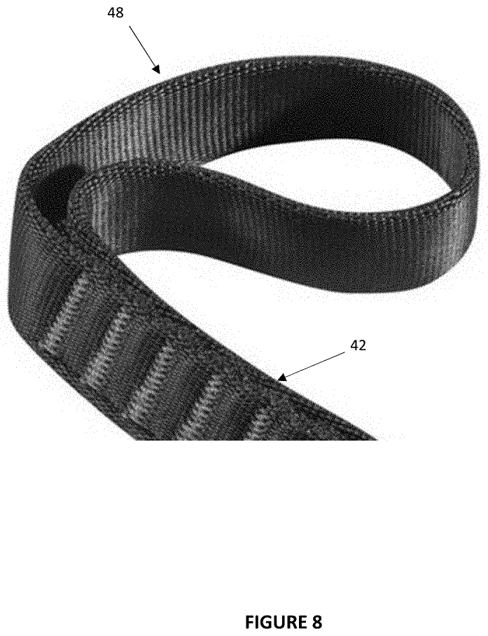

FIG. 8 is a perspective view of the handle 48 that may be attached or formed on the pulling end of the release tool 40. The first embodiment forms the handle 48 from the fabric webbing shaft 42 because it is advantageous to use it when the webbing material is already of a high tensile strength.

In an alternative embodiment of the invention, the hook 46 on the working end may be replaced by a loop of wire or a separate piece of fabric webbing.

While the hook 46 of the first embodiment may provide a large surface area for engaging the latch mechanism 22, any hook or loop that will not slip off the latch mechanism may be used on the working end of the release tool 40.

It is noted that it may be convenient to seal the metal blades 44 within the release tool 40 so that the metal blades do not slide up into the handle 48. This may be accomplished using a simple stitch or staple in the fabric webbing shaft 42. However, it is also noted that it may be important to not sew the fabric webbing shaft 42 at the exact end of the metal blade 44. A space should be left in the fabric webbing shaft 42 for the metal blade 44 to slide as the fabric webbing shaft and the metal blade 44 are both rolled up or folded for storage. For example, there may be a half inch gap between the ends of the metal blade 44 and the ends of the fabric webbing shaft 42. If this gap is not left in the fabric webbing shaft 42, the metal blade 44 may not be able to roll up or fold completely as it slides within the fabric webbing shaft.

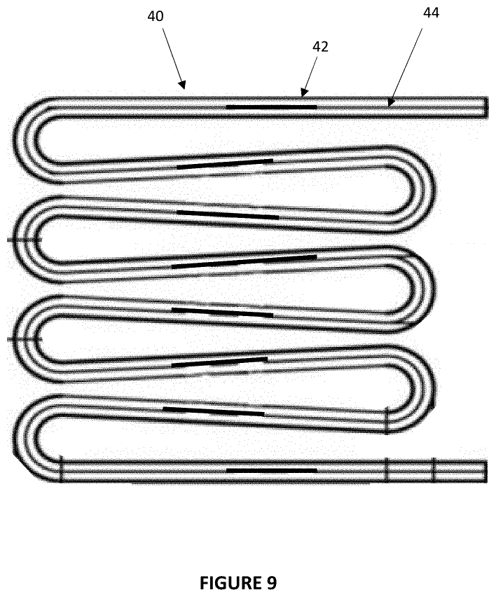

FIG. 9 is a profile view of the release tool 40 that has been folded in a serpentine shape for storage. The ends of the release tool 40 are shown without the hook 46 and the handle 48, but is instead illustrating how the fabric webbing shaft 42 and the metal blade 44 disposed inside may be folded for storage. The actual release tool 40 is much more compact when folded but is shown in this form to illustrate the folds in the fabric webbing shaft 42.

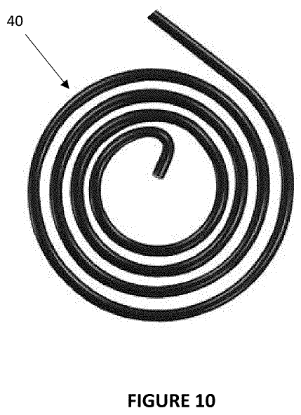

FIG. 10 is a profile view of another possible method of folding the release tool 40 for storage. In this figure, the release tool 40 is shown coiled like a spring. The ends of the release tool 40 are again shown without the hook 46 and the handle 48.

It should be understood that the foldable release tool of the present invention may also be used as another type of tool, wherein the tool may have a different type of tool on a working end. Whereas the release tool of the present invention includes a hook on the working end, a different tool may be substituted for the hook. Accordingly, the release tool of the present invention may be a different tool that may also be folded or rolled up in a compact manner for storage, and then unfolded or unrolled and then used with whatever tool is disposed on the working end.

The hook disposed on the working end of the release tool may be removed from the working end by releasing it from working end of the fabric webbing shaft. Accordingly, the working end may have a closure mechanism that enables replacement of a tool at the working end.

In summary, the present invention may be a foldable release tool for reaching under a semi-trailer to activate a release mechanism, said release tool comprised of: a fabric webbing shaft, wherein the fabric webbing shaft is formed as a tubular length of webbing, a metal blade having a convex surface and an opposite convex surface, wherein the metal blade is disposed within the fabric webbing shaft, wherein the metal blade is shorter than the length fabric webbing shaft, and wherein the metal blade may be folded without making a permanent mechanical deformation in the metal blade, a hook coupled to a working end of the release tool, and a handle coupled to a pulling end of the release tool.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A foldable release tool for reaching under a semi-trailer to activate a release mechanism, said release tool comprised of:
a fabric webbing shaft, wherein the fabric webbing shaft is formed as a tubular length of webbing;
a metal blade having a convex surface and an opposite convex surface, wherein the metal blade is disposed within the fabric webbing shaft, wherein the metal blade is shorter than the length fabric webbing shaft, and wherein the metal blade may be folded without making a permanent mechanical deformation in the metal blade;
a hook coupled to a working end of the release tool; and
a handle coupled to a pulling end of the release tool.

2. The foldable release tool as defined in claim 1 wherein the fabric webbing shaft is further comprised of a Denier Nylon webbing material.

3. The foldable release tool as defined in claim 1 wherein the release tool is further comprised of the handle being formed from the fabric webbing shaft, wherein the fabric webbing shaft is folded back on itself to form a loop made from the fabric webbing shaft, and wherein the loop is completed by attaching the fabric webbing shaft to itself to form the loop.

4. The foldable release tool as defined in claim 1 wherein the metal blade is selected from the group of materials comprised of nylon, plastic, rigid rubber, aluminum, a composite, or steel.

5. A method of using a foldable release tool for reaching under a semi-trailer to activate a release mechanism, said method comprising:
providing a fabric webbing shaft, wherein the fabric webbing shaft is formed as a tubular length of webbing, providing a metal blade having a convex surface and an opposite convex surface, wherein the metal blade is disposed within the fabric webbing shaft, wherein the metal blade is shorter than the length fabric webbing shaft, providing a hook coupled to a working end of the release tool, and providing a handle coupled to a pulling end of the release tool;
extending the fabric webbing shaft to form a flat surface;
holding the fabric webbing shaft at the handle;
reaching under the semi-trailer;
attaching the hook onto the release mechanism;
pulling on the handle to activate the release mechanism; and
removing the hook from the release mechanism.

6. The method as defined in claim 5 wherein the method further comprises releasing the kingpin of a semi-trailer when the release mechanism is activated.

7. The method as defined in claim 5 wherein the method further comprises:
folding the fabric webbing shaft to reduce the length of the release tool, wherein the fabric webbing shaft is folded at least once; and
storing the release tool for later use.

8. The method as defined in claim 5 wherein the method further comprises:
rolling the fabric webbing shaft into a spiral shape; and
storing the release tool for later use.

9. The method as defined in claim 5 wherein the method further comprises folding the metal blade without making a permanent mechanical deformation in the metal blade.
